(19) United States
(12) Patent Application Publication
(10) Pub. No.: US 2005/0047697 A1
(43) Pub. Date: Mar. 3, 2005

(54) Bearing assembly

(75) Inventors: Huageng Shao, Si Hsien (CN); Kun-Yee Yang, Panchiao City (TW)

Correspondence Address: LADAS & PARRY, 26 WEST 61ST STREET, NEW YORK, NY, 10023, US

(73) Assignee: BENQ CORPORATION

(21) Appl. No.: 10/931,420

(22) Filed: Sep. 1, 2004

(30) Foreign Application Priority Data
Sep. 1, 2003 (TW) 92124100

(51) Int. Cl. F16C 43/00; F16C 25/04; F16C 23/08; F16C 23/04

(52) U.S. Cl. 384/540

(57) ABSTRACT

A bearing assembly includes an outer threaded member having a bolt head at one end thereof, a threaded portion at the other end thereof, a bearing-retention recess, and an opening for access to the bearing-retention recess. A bearing unit is disposed in the recess to hold a shaft that is inserted into the bearing unit via the opening.

### FIELD OF THE INVENTION

The present invention relates to a bearing assembly, specifically to a bearing assembly that is adapted be mounted securely on a thin wall.

### BACKGROUND OF THE INVENTION

When mounting a bearing assembly on a mounting wall, a bearing-retention recess is generally formed in the mounting wall. The bearing assembly is fittingly inserted into the recess. Then, the constricted end of a rotating shaft is inserted into the bearing assembly. The mounting wall must be relatively thick in order to provide sufficient strength to withstand the rotating action of the shaft, since some shafts rotate at high speed in order to achieve a predetermined purpose. In case, the mounting wall is relatively thin, the latter usually cannot provide sufficient strength to hold the shaft firmly in the bearing assembly.

FIG. 1 show a perspective and sectional view, illustrating mounting of a bearing assembly 3 within a mounting hole 22 of a thin wall 1 by means of U-shaped positioning braces 4. FIG. 2 is a sectional view taken along lines (a-a) in FIG. 1. Each of the positioning braces 4 has a base portion 42 fixed to the periphery defining the mounting hole 22, and two retaining flanges 41 sandwiching two opposite sides of the bearing assembly 3 so as to prevent untimely disengagement of the bearing assembly 3 from the thin wall 1. The constricted end 20 of a rotating shaft 2 is inserted into the bearing assembly 3 so as to permit rotation of the rotating shaft 2 about an axis (CL).

Some disadvantages resulting from the use of aforesaid bearing assembly are as follows:

(i) Since the base portion 42 of the respective positioning brace 3 is fastened partially to the thin wall 1, the stability of the bearing assembly 3 retained by the positioning braces 4 is poor.

(ii) The bearing assembly 3 may drop off the mounting hole 22 in the thin wall 1, in case the rotating speed of the shaft 2 is relatively great, similar to those used in the gear box of a vehicle.

### SUMMARY OF THE INVENTION

The object of the present invention is to provide a bearing assembly of a unique arrangement which can eliminate the aforesaid disadvantages that result from mounting of the conventional bearing assembly on the thin wall.

According to a first aspect of the present invention, a bearing assembly is provided to include: an outer threaded member formed as a tubular body that defines an axis and that includes a bolt head at one end thereof for receiving an external force to rotate the outer threaded member about the axis, and a threaded portion at the other end thereof and having external threads for fastening purposes, the outer threaded member further including a bearing-retention recess extending along the axis and of a cylindrical-shaped cross-section, and an opening for access to the bearing-retention recess; and a bearing unit disposed within the bearing-retention recess for holding a shaft which is to be inserted into the bearing unit via the opening.

According to a second aspect of the present invention, a bearing assembly is provided to include: an outer threaded member formed as a tubular body that defines an axis and that includes a bolt head at one end thereof for receiving an external force to rotate the outer threaded member about the axis, and a threaded portion at the other end thereof and having external threads for fastening purposes, the outer threaded member further including a bearing-retention recess extending along the axis and of a cylindrical-shaped cross-section, and an opening for access to the bearing-retention recess; at least one bearing unit disposed within the bearing-retention recess for holding a shaft which is to be inserted into the bearing unit via the opening; and a nut member having internal threads for fastening the external threads of the threaded portion; wherein, when the bearing assembly is mounted on a thin wall having a mounting bore, the threaded portion extends through the mounting bore to dispose the bolt head at one side of the thin wall while the internal threads of the nut member mesh with the external threads of the threaded portion. When the nut member is tightened relative to the outer threaded member, the bearing assembly is mounted securely on the thin wall by virtue of tight abutment of the bold head and the nut member against two opposite sides of the thin wall.

According to a third aspect of the present invention, a bearing assembly is provided to include: an outer threaded member formed as a tubular body that defines an axis and that includes a bolt head at one end thereof for receiving an external force to rotate the outer threaded member about the axis, and a threaded portion at the other end thereof and having external threads for fastening purposes, the outer threaded member including a bearing-retention recess extending along the axis, of a cylindrical-shaped cross-section, and opening for access to the bearing-retention recess, the outer threaded member further including an annular outer channel that is formed on a recess-confining wall of the bearing-retention recess; an inner race formed as a hollow cylinder disposed in said bearing-retention recess, and having an outer surface formed with an annular inner channel corresponding to the annular outer channel of the outer threaded member; and a plurality of rolling balls disposed between the annular outer and inner channels of the outer threaded member and the inner race.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view , illustrating mounting of a conventional bearing assembly on a thin wall;

FIG. 2 is a sectional view taken along lines (a-a) in FIG. 1;

FIG. 3 is an exploded perspective view of the first preferred embodiment of a bearing assembly according to the present invention;

FIG. 4 is a sectional view of the first preferred embodiment of the bearing assembly according to the present invention, when mounted on a thin wall and receiving a shaft therein;

FIG. 5 is a sectional view of the second preferred embodiment of a bearing assembly according to the present invention receiving a shaft therein;

FIG. 6A is an exploded view of the third preferred embodiment of a bearing assembly according to the present invention;

FIG. 6B is a sectional view of the third preferred embodiment of a bearing assembly according to the present invention;

FIG. 7 is a sectional view of the fourth preferred embodiment of a bearing assembly according to the present invention;

FIG. 8 is a sectional view of the fifth preferred embodiment of a bearing assembly according to the present invention;

FIG. 9 is a sectional view of the sixth preferred embodiment of a bearing assembly according to the present invention; and

FIG. 10 is a sectional view of the seventh preferred embodiment of a bearing assembly according to the present invention.

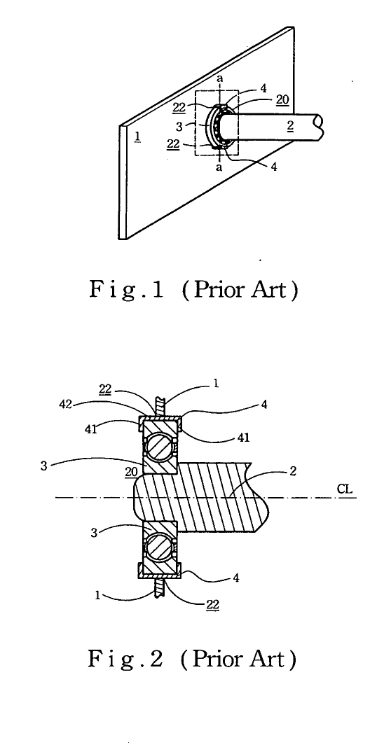

### DETAILED DESCRIPTION OF THE PREFERRED EMBODIMENTS

Before the present invention is described in greater detail with reference to the following embodiments, it should be noted that same reference numerals have been used to denote similar elements throughout the specification.

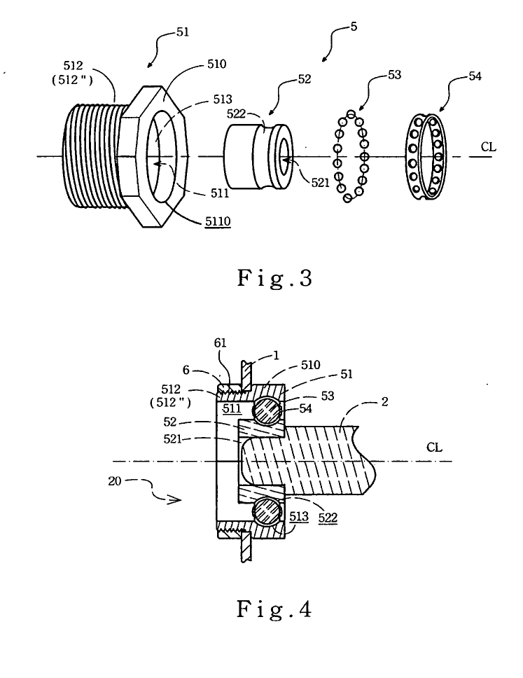

Referring to FIG. 3, the first embodiment of a bearing assembly 5 according to the present invention is shown to include an outer threaded member 51 and a bearing unit. The bearing unit, for example, is ball-type bearing member, includes an outer race (not visible), an inner race 52, a plurality of rolling balls 53, and a retaining ring 54.

As illustrated, the outer threaded member 51 is formed as a tubular body that defines an axis and that includes a bolt head 510 at one end thereof for receiving an external force to rotate the outer threaded member 51 about the axis (CL), and a threaded portion 512 at the other end thereof and having external threads for fastening purposes. The outer threaded member 51 further includes a bearing-retention recess 511 extending along the axis and of a cylindrical-shaped cross-section, and an opening 5110 for access to the bearing-retention recess 511. The bearing unit is disposed within the bearing-retention recess 511 for holding the constricted end of a shaft 2, which is inserted into the bearing unit via the opening 5110 of the outer threaded member 51 (see FIG. 4). One example, the bolt head 510 is constructed to have a hexagonal configuration so as to be gripped by a wrench or spanner (not shown) to facilitate turning of the outer threaded member 51 about the axis (CL).

In the first embodiment, the opening 5110 is formed on the bold head 510. The bearing-retention recess 511 is defined by a recess-confining wall that serves as the outer race and that is formed with an annular outer channel 513 (see FIG. 4). The inner race 52 is formed as a hollow cylinder, is disposed in the bearing-retention recess 511, and has an outer surface formed with an annular inner channel 522 corresponding to the annular outer channel 513 of the outer threaded member 51. The rolling balls 53 are disposed between the annular outer and inner channels 513, 522 of the outer threaded member 51 and the inner race 52. The retaining ring 54 is sleeved around the rolling balls 53 in such a manner to confine the rolling balls 53 between the inner and outer races 52.

FIG. 4 illustrates how the first embodiment of a bearing assembly is mounted on a thin wall 1 having a mounting hole 20. Under this condition, the threaded portion 512 extends through the mounting hole 20 so as to dispose the bolt head 510 at one side of the thin wall 1. A nut 6 is disposed on the other side of the thin wall 1, and is fastened threadedly on the threaded portion 512 in such a manner that tightening of the nut 6 relative to the threaded portion 512 results in tight abutment of the nut 6 and the bolt heads 510 against two opposite sides of the thin wall 1 by virtue of engagement between the external and internal threads 512″, 61 of the threaded portion 512 and the nut 6. The bearing assembly 5 of the present invention is thus mounted securely on the thin wall 1 compared to that shown in FIG. 2, since the entire peripheries of the nut 6 and the bolt head 510 are in tight engagement with the two opposite sides of the thin wall 1. The constricted end of the rotating shaft 2 is received in a holding bore 521 that is formed in the inner race 52.

In this first embodiment, the bearing-retention recess 511 is a through hole that has two opposite open ends, one of the open ends is formed on the bold head 510 to define the opening 5110 while the other one of the open ends is formed on the threaded portion 512 opposite to the opening 5110. The external threads 512″ extend along an entire length of the threaded portion 512.

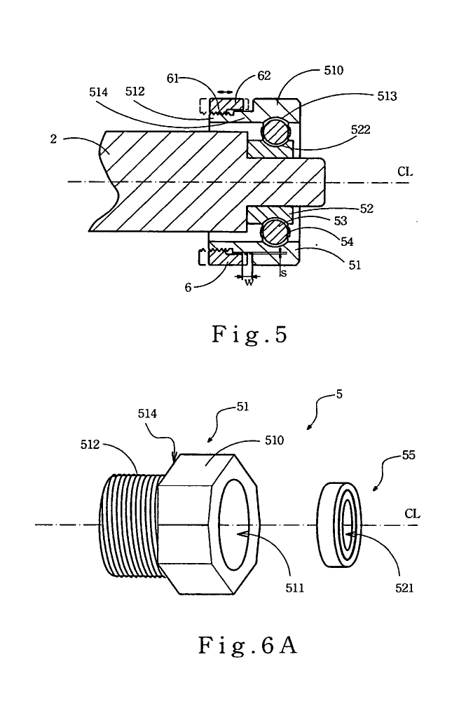

FIG. 5 shows a sectional view of the second embodiment of a bearing assembly 5 according to the present invention, and has a construction similar to that of the first embodiment. The main difference resides in that the external threads 512″ (see FIG. 3) is partially formed on the threaded portion 512 such that the threaded member 51 further includes a non-threaded portion 514 of a predetermined length between the bolt head 510 and the threaded portion 512. The nut member 6 further includes an axially extending adjusting flange 62. The length (W) of the adjusting flange 62 can be varied as shown by dotted lines in order to overlap fully or partially the non-threaded portion 514 of the outer threaded member 51 so as to prevent interference between the nut member 6 and the outer threaded member 51 when mounting the bearing assembly 5 of the present invention on a thin wall. In case, the second embodiment is mounted on a thin wall (not shown), and the nut member 6 is tightened relative to the outer threaded member 51 so as to tightly abut against two opposite sides of the thin wall 1. The adjusting flange 62 cooperates with the non-threaded portion 514 to define a clearance (S) therebetween. Alternatively, a washer or a plurality of washers (not shown) can be used instead of the adjusting flange 62.

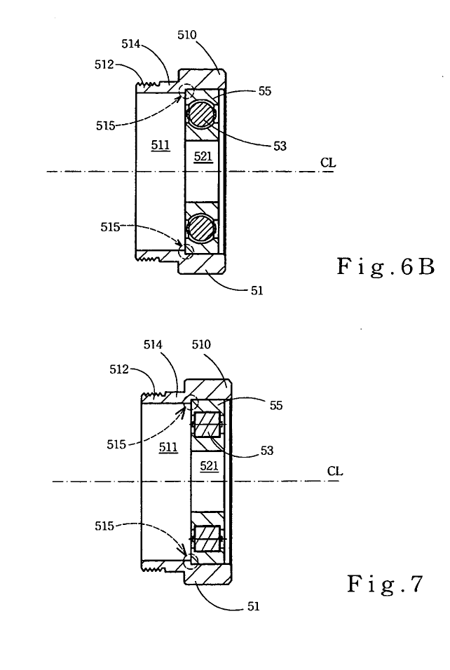

Referring to FIGS. 6A and 6B, the third embodiment of a bearing assembly 5 according to the present invention is shown, and has a construction similar to that of the second embodiment. The main difference resides in that the bearing-retention recess 511 is a counter bore that includes two diameter-different sections so as to form a shoulder 515 adjacent to the bolt head 510 to receive the bearing unit 55.

Referring to FIG. 7, the fourth embodiment of a bearing assembly according to the present invention is shown. Unlike to the third embodiment, the bearing unit employed in the fourth embodiment is a roller-type bearing member.

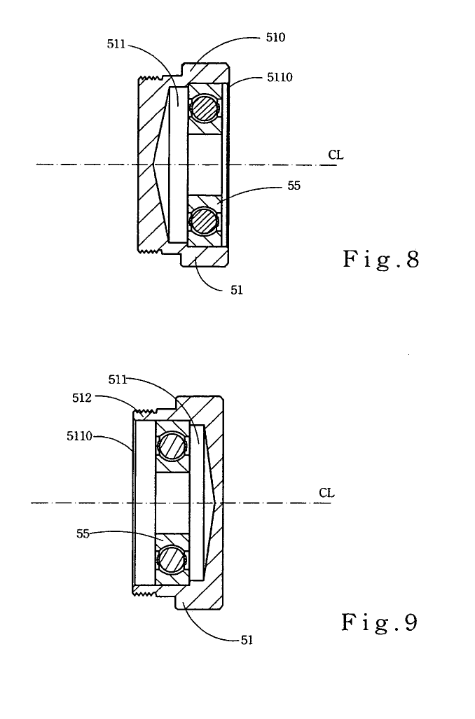

Referring to FIG. 8, the fifth embodiment of a bearing assembly according to the present invention is shown and has a construction similar to the above embodiments. The only difference resides in that the bearing-retention recess 511 is a blind bore, and the opening 5110 is formed on the bolt head 510.

Referring to FIG. 9, the sixth embodiment of a bearing assembly according to the present invention is shown and has a construction similar to the fifth embodiment. The only difference resides in that the bearing-retention recess 511 is a blind bore and the opening 5110 is formed on the threaded portion 512.

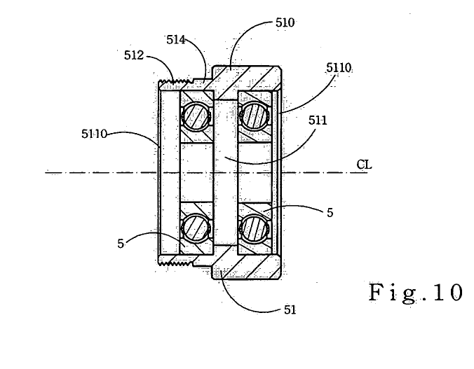

Referring to FIG. 10, the seventh embodiment of a bearing assembly according to the present invention is shown, in which the bearing-retention recess 511 is a through hole with two opposite open ends. The outer threaded member 51 further includes an annular positioning flange that extends inwardly and radially from the recess-confining wall of the bearing-retention recess 511. Two bearing units 5 (55) of FIG. 4 or FIG. 7 can be disposed in the bearing-retention recess 511, and are respectively seated on two opposite sides of the positioning flange.

While the present invention has been described in connection with what is considered the most practical embodiments, it is understood that this invention is not limited to the disclosed embodiments but is intended to cover various arrangements included within the spirit and scope of the broadest interpretation so as to encompass all such modifications and equivalent arrangements.

1. A bearing assembly comprising:
an outer threaded member formed as a tubular body that defines an axis and that includes a bolt head at one end thereof for receiving an external force to rotate said outer threaded member about the axis, and a threaded portion at the other end thereof and having external threads for fastening purposes, said outer threaded member further including a bearing-retention recess extending along the axis and of a cylindrical-shaped cross-section, and an opening for access to said bearing-retention recess; and
a bearing unit disposed within said bearing-retention recess for holding a shaft which is to be inserted into said bearing unit via said opening.

2. The bearing assembly according to claim 1, wherein said opening is formed on said bold head.

3. The bearing assembly according to claim 1, wherein said opening is formed on said threaded portion.

4. The bearing assembly according to claim 1, wherein said bearing-retention recess is a through hole that has two opposite open ends, one of said open ends being formed on said bold head to define said opening, the other one of said open ends being formed on said threaded portion opposite to said opening.

5. The bearing assembly according to claim 1, wherein said bearing unit is a ball-type bearing member.

6. The bearing assembly according to claim 1, wherein said bearing unit is a roller-type bearing member.

7. The bearing assembly 5 according to claim 1, wherein said bearing unit includes an outer race that is disposed within said outer threaded member and that is integrally formed therewith, an inner race, and a plurality of rolling balls confined between said outer and inner races.

8. The bearing assembly according to claim 1, wherein said external threads extend along an entire length of said threaded portion.

9. The bearing assembly according to claim 1, wherein said external threads are formed only on a predetermined length of said threaded portion.

10. A bearing assembly 5 comprising:
an outer threaded member formed as a tubular body that defines an axis and that includes a bolt head at one end thereof for receiving an external force to rotate said outer threaded member about the axis, and a threaded portion at the other end thereof and having external threads for fastening purposes, said outer threaded member further including a bearing-retention recess extending along the axis and of a cylindrical-shaped cross-section, and an opening for access to said bearing-retention recess;
at least one bearing unit disposed within said bearing-retention recess for holding a shaft which is to be inserted into said bearing unit via said opening; and
a nut member having internal threads for fastening said external threads of said threaded portion;
wherein, when said bearing assembly is mounted on a thin wall having a mounting bore, said threaded portion extends through the mounting bore to dispose said bolt head at one side of the thin wall while said internal threads of said nut member mesh with said external threads of said threaded portion, tightening of said nut member relative to said outer threaded member results in firm mounting of said bearing assembly on the thin wall.

11. The bearing assembly according to claim 10, wherein said opening is formed on said bold head.

12. The bearing assembly according to claim 10, wherein said opening is formed on said threaded portion.

13. The bearing assembly according to claim 10, wherein said bearing-retention recess is a through hole that has two opposite open ends, one of said open ends being formed on said bold head to define said opening, the other one of said open ends being formed on said threaded portion opposite to said opening.

14. The bearing assembly according to claim 10, wherein said bearing unit includes an outer race that is disposed within said outer threaded member and that is integrally formed therewith, an inner race, and a plurality of rolling balls confined between said outer and inner races.

15. The bearing assembly according to claim 10, wherein said outer threaded member further includes a non-threaded portion of a predetermined length between said bolt head and said threaded portion, said nut member further including an axially extending adjusting flange therefrom, wherein when said nut member is tightened relative to said outer threaded member, said adjusting flange tightly abuts against the thin wall and subsequently forms a clearance between said adjusting flange and said non-threaded portion.

16. A bearing assembly comprising:
an outer threaded member formed as a tubular body that defines an axis and that includes a bolt head at one end thereof for receiving an external force to rotate said outer threaded member about the axis, and a threaded portion at the other end thereof and having external threads for fastening purposes, said outer threaded member including a bearing-retention recess extending along the axis, of a cylindrical-shaped cross-section, and opening for access to said bearing-retention recess, said outer threaded member further including an annular outer channel that is formed on a recess-confining wall of said bearing-retention recess;
an inner race formed as a hollow cylinder disposed in said bearing-retention recess, and having an outer surface formed with an annular inner channel corresponding to said annular outer channel of said outer threaded member; and
a plurality of rolling balls disposed between said annular outer and inner channels of said outer threaded member and said inner race.

17. The bearing assembly according to claim 16, wherein said opening is formed on said bold head.

18. The bearing assembly according to claim 16, wherein said opening is formed on said threaded portion.

19. The bearing assembly according to claim 16, wherein said bearing-retention recess is a through hole that has two opposite open ends, one of said open ends being formed on said bold head to define said opening, the other one of said open ends being formed on said threaded portion opposite to said opening.

20. The bearing assembly according to claim 16, wherein said outer threaded member further includes a non-threaded portion of a predetermined length disposed between said bolt head and said threaded portion.
